(19) United States
(12) Patent Application Publication
(10) Pub. No.: US 2005/0197452 A1
(43) Pub. Date: Sep. 8, 2005

(54) Safety equipment comprising an aromatic polyamide composition, and aromatic polyamide composition

(75) Inventors: Bruce Bersted, Cumming, GA (US); Timothy D. Bishop, Oxford, PA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: SOLVAY ADVANCED POLYMERS, LLC, Alpharetta, GA (US)

(21) Appl. No.: 11/062,695

(22) Filed: Feb. 23, 2005

Related U.S. Application Data
(60) Provisional application No. 60/547,840, filed on Feb. 27, 2004.

(51) Int. Cl. C08J 3/00

(52) U.S. Cl. 525/66

(57) ABSTRACT

Safety equipment comprising a polymer composition comprising: an aromatic polyamide, and above 10 wt. %, based on the total weight of the polymer composition, of at least one functionalized polyolefin impact modifier having a glass transition temperature below −10° C. Polymer composition comprising: an aromatic polyamide, and above 10 wt. %, based on the total weight of the polymer composition, of at least one functionalized polyolefin impact modifier having a glass transition temperature below −10° C.

### CROSS-REFERENCE TO RELATED APPLICATIONS

The present application claims the benefit of U.S. application Ser. No. 60/547,840, filed Feb. 27, 2004, incorporated herein by reference.

### BACKGROUND OF THE INVENTION

Safety equipment is required by many occupations. Safety equipment can be used to protect the wearer from mechanical impact, exposure to temperature extremes, and protection from actinic radiation. An example of safety equipment is protective face and head gear, such as welding helmets and masks. For comfort and ease of use it is desirable that safety equipment be light weight. Polymeric compositions are useful for making light-weight safety equipment.

Three characteristics are paramount in protective face and head gear, such as welding helmets and masks. First, the helmet/mask must have thermal characteristics that protect the wearer from molten metal and sparks during welding. Second, the helmet/mask must have an opacity level such that no damaging ultraviolet (UV) light is transmitted through the welding helmet/mask and damages the welder's eyesight. Third, the helmet/mask must have good impact properties.

### SUMMARY OF THE INVENTION

In order to provide a robust safety equipment that would consistently meet or exceed end use requirements and solve the problems associated with long flow lengths, inconsistent impact strength, and poor surface aesthetics, new and improved polymer compositions were investigated.

An aspect of the present invention concerns a safety equipment comprising a polymer composition comprising an aromatic polyamide, and above 10 wt. %, based on the total weight of the polymer composition, of at least one functionalized polyolefin impact modifier having a glass transition temperature below −10° C.

### DETAILED DESCRIPTION OF THE INVENTION

It is an objective of the present invention to provide a robust safety equipment that consistently meets or exceeds end use requirements and solves the problems associated with long flow lengths, inconsistent impact strength, and poor surface aesthetics.

With this end in view, the present invention concerns a safety equipment comprising a polymer composition comprising:
an aromatic polyamide, and
above 10 wt. %, based on the total weight of the polymer composition, of at least one functionalized polyolefin impact modifier having a glass transition temperature below −10° C.

In certain embodiments of the present invention, the safety equipment is a protective face or head gear. In certain embodiments of the present invention, the safety equipment is a welding helmet or mask.

In certain embodiments of the present invention, the safety equipment comprises more than 10 wt. %, based on the total weight of the safety equipment, of the polymer composition. In certain embodiments of the present invention, the safety equipment comprises more than 25 wt. %, based on the total weight of the safety equipment, of the polymer composition. In certain embodiments of the present invention, the safety equipment comprises more than 50 wt. %, based on the total weight of the safety equipment, of the polymer composition.

To the purpose of the present invention, “aromatic polyamide” is intended to denote any polymer comprising at least 50 mole % of recurring units formed by the polycondensation reaction between at least one aromatic diacid and at least one diamine. The diamine can be either aliphatic or aromatic. Metaxylylenediamine is an example of aromatic diamine.

In certain embodiments of the present invention, the aromatic polyamide is a polyphthalamide, i.e. an aromatic polyamide comprising recurring units formed by the polycondensation reaction between at least one phthalic diacid and at least one diamine. In certain embodiments of the present invention, the aromatic polyamide has a melting point greater than 280° C. Suitable polyphthalamides included within the scope of invention include any partially aromatic polyphthalamide, i.e. any polyphthalamide further comprising recurring units formed by the polycondensation reaction between at least one aliphatic diacid and at least one diamine. Suitable polyphthalamides for certain embodiments of the present invention comprise recurring units formed by the polycondensation reaction between at least one phthalic diacid and at least one aliphatic diamine. In certain embodiments, the phthalic acid is terephthalic acid. In certain other embodiments of the present invention, the phthalic acid comprises terephthalic acid and isophthalic acid. In other certain embodiments of the present invention, the polyphthalamide further comprises recurring units formed by the polycondensation reaction between at least one aliphatic diacid, such as adipic acid, and at least one aliphatic diamine. In certain other embodiments of the present invention, the diamine is an aliphatic diamine comprising from 4 to 12 carbon items, such as hexamethylenediamine (HMDA), nonanediamine, 2-methyl-1,5 pentadiamine, and 1,4-diaminobutane.

In certain embodiments of the present invention, from at least about 40 mole % to about 100 mole % of dicarboxylic acid used in forming the aromatic polyamide is chosen from aromatic dicarboxylic acids. In certain embodiments of the present invention, the aromatic polyamide comprises:
from about 50 mole % to about 100 mole % of terephthalamide recurring units (i.e. recurring units formed by the polycondensation reaction between terephthalic acid and at least one aliphatic diamine, in particular hexamethylene diamine),
from about 35 mole % to about 0 mole % of isophthalamide recurring units (i.e. recurring units formed by the polycondensation reaction between isophthalic acid and at least one aliphatic diamine, in particular hexamethylene diamine), and
from about 50 mole % to about 0 mole % of recurring units formed by the polycondensation reaction between at least one aliphatic diacid and at least one aliphatic diamine (in particular adipamide recurring units, i.e. recurring units formed by the polycondensation reaction between adipic acid and at least one aliphatic diamine, in particular hexamethylene diamine).

In certain embodiments of the present invention, the aromatic polyamide comprises up to about 75 mole % terephthalamide recurring units. In certain other embodiments of the present invention, the aromatic polyamide comprises up to about 60 mole % terephthalamide units. In certain embodiments of the present invention, the aromatic polyamide comprises at least about 10 mole % adipamide recurring units. In certain other embodiments of the present invention, the aromatic polyamide comprises at least about 30 mole % adipamide recurring units. In certain other embodiments of the present invention, the aromatic polyamide comprises at least about 40 mole % adipamide recurring units. In certain embodiments of the present invention, the aromatic polymer comprises up to about 10 mole % isophthalamide recurring units.

Suitable aromatic polyamides for embodiments of the present invention in the present invention are available as AMODEL® polyphthalamides from Solvay Advanced Polymers, L.L.C.

Suitable polyphthalamides for certain other embodiments of the present invention are disclosed in U.S. Pat. Nos. 5,436,294; 5,447,980 ; and Re34,447, the entire disclosures of which are incorporated herein by reference.

In certain embodiments of the present invention, the polymer composition comprises at least about 30% by weight of the aromatic polyamide. In certain embodiments of the present invention, the polymer composition comprises at least about 50% by weight of the aromatic polyamide. In certain embodiments of the present invention, the polymer composition comprises up to about 80 weight % of the aromatic polyamide.

In certain embodiments of the present invention, the polymer composition comprises at least about 15% by weight of the functionalized polyolefin impact modifier. In certain embodiments of the present invention, the polymer composition comprises up to about 35 weight % of the functionalized polyolefin impact modifier. In certain embodiments of the present invention, the polymer composition comprises up to about 30 weight % of the functionalized polyolefin impact modifier. In certain embodiments of the present invention, the polymer composition comprises up to about 25 weight % of the functionalized polyolefin impact modifier. In certain embodiments of the present invention, the polymer composition comprises about 20 weight % of the functionalized polyolefin impact modifier.

Any functionalized polyolefin impact modifier that has a glass transition temperature lower than −10° C. is suitable for this invention.

In certain embodiments of the present invention, the functionalized polyolefin impact modifier has one and only one glass transition temperature. In certain other embodiments of the present invention, the functionalized polyolefin impact modifier is a block copolymer which has two or still more glass transition temperatures, at least one of them being lower than −10° C. To the purpose of the present invention, functionalized polyolefin impact modifiers having one and only one glass transition temperature are preferred over functionalized polyolefin impact modifiers having two or more glass transition temperatures.

In certain embodiments of the present invention, the functionalized polyolefin impact modifier has a glass transition temperature of less than about −20° C. In certain embodiments of the present invention, the functionalized polyolefin impact modifier has a glass transition temperature of less than about −30° C. In certain embodiments of the present invention, the functionalized polyolefin impact modifier has a glass transition temperature of above about −65° C.

Suitable functionalized polyolefin impact modifiers for use in certain embodiments of the present invention, are soft and rubbery.

Suitable functionalized polyolefin impact modifiers for use in certain embodiments of the present invention, comprise polar functional groups. In certain embodiments of the invention, the functionalized polyolefin impact modifier comprises carboxyl functionality. In certain embodiments of the invention, the functionalized polyolefin impact modifier comprises at least about 0.1 weight % of carboxyl functionality. In certain other embodiments of the invention, the functionalized polyolefin impact modifier comprises up to about 5 weight % carboxyl functionality.

The functionalized polyolefin impact modifier that may be used in certain embodiments of the present invention include those having a melt flow rate (MFR) of at least about 0.5 g/10 min. The MFR of the functionalized polyolefin impact modifier according to certain embodiments of the present invention may be up to about 200 g/10 min.

In certain embodiments of the present invention, the functionalized impact modifier is dispersed in the aromatic polyamide. In certain polymer compositions used to form embodiments of the present invention, the functionalized impact modifier comprises polar groups that react with the aromatic polyamide, which results in enhanced adhesion to the aromatic polyamide matrix.

Suitable functionalized polyolefin impact modifiers are available from various commercial sources, notably:
maleic anhydride-functionalized ethylene-propylene copolymer rubbers comprising pendant succinic anhydride groups available as EXXELOR® VA from the Exxon Mobil Chemical Company, such as EXXELOR® VA 1801,
maleic anhydride-functionalized styrene/ethylene-butylene/styrene block copolymer rubbers available as KRATON® FG from Kraton Polymers, such as KRATON® FG1901X,
maleic anhydride-functionalized ethylene-propylene-diene terpolymer rubbers (EPDM), such as ROYALTUF® 498, a 1% maleic anhydride functionalized EPDM, available from the Crompton Corporation.

Suitable functionalized polyolefin impact modifiers for use in certain embodiments of the present invention comprise recurring units derived from ethylene and/or propylene. Suitable functionalized polyolefin impact modifiers for use in certain embodiments of the present invention comprise further recurring units derived from one or more monomers chosen from monoolefins comprising from 4 to 12 carbon atoms like 1-butene and 1-hexene, diolefins like butadiene, (meth)acrylic monomers such as (meth)acrylic acid and its alkali (like sodium) or alkaline-earth (link zinc) metal salts and (meth)acrylic acid ester(s). Recurring units derived from diolefins can be hydrogenated; an example of a functionalized polyolefin impact modifier wherein recurring units derived from butadiene have been hydrogenated is KRATON® FG1901X, a 1% maleic anhydride grafted styrene/ethylene-butylene/styrene block copolymer comprising about 30 wt. % of polystyrene blocks available from Kraton Polymers.

The functionality of the functionalized polyolefin impact modifiers can be obtained by copolymerizing one or more functional monomers and/or by grafting one or more functional monomers. In particular, carboxyl functionality of the functionalized polyolefin impact modifiers can be obtained by copolymerizing one or more acrylic monomers chosen from acrylic acid and methacrylic acid, their alkali (like sodium) or alkaline-earth (link zinc) metal salts, acrylic acid esters and methacrylic acid esters. It can also be obtained by grafting one or more of said monomers, or anhydrides like maleic anhydride. Carboxylic acid groups can be partially or totally neutralized by an alkaline or alkaline-earth hydroxide or salt subsequent to the copolymerization or the grafting step.

In certain embodiments of the present invention functionalized polyolefin impact modifiers comprise recurring units derived from ethylene and propylene, with a ratio of ethylene radicals to propylene recurring units of from 40:60 to 65:30.

Functionalized ethylene/acrylate copolymers and ethylene/acrylic acid/acrylate terpolymers, as well as the corresponding co- and terpolymers with methacrylic derivatives, may be used in certain embodiments of the present invention provided they have a glass transition temperature below −10° C. Examples thereof are functionalized rubbery ethyl acrylate-ethylene copolymers.

Other functionalized polyolefin impact modifiers that may be used in the practice of the invention include ethylene-higher alpha-olefin polymers that have been provided with reactive functionality by being grafted or copolymerized with suitable reactive carboxylic acids or their derivatives such as, for example, acrylic acid, methacrylic acid, maleic anhydride or their esters (impact modifiers (IM1)); they will have advantageously a tensile modulus up to about 50,000 psi determined according to ASTM D-638. Suitable higher alpha-olefins include C₃ to C₈ alpha-olefins such as, for example, propylene, 1-butene, and 1-hexene. Examples of suitable functionalized ethylene-higher alpha-olefin polymers are ethylene-1-octene elastomers available as ENGAGE® from DuPont (such as ENGAGE® 8550), on which maleic anhydride has been grafted.

Alternatively, functionalized polyolefin impact modifiers having structures comprising similar units may also be obtained through a hydrogenation step of the recurring units derived from 1-3 diene monomers (impact modifiers (IM2)). For example, polybutadienes having varying levels of pendant vinyl units are readily obtained, and these may be hydrogenated to provide ethylene-butylene copolymers structures. Similarly, hydrogenation of polyisoprenes may be employed to provide equivalent ethylene-isobutylene copolymers.

A class of functionalized polyolefin impact modifiers of particular interest consists of polymers comprising recurring units from ethylene, at least one higher alpha-olefin polymer and at least one diene, and that have been provided with reactive functionality by being grafted or copolymerized with suitable reactive carboxylic acids or their derivatives such as, for example, acrylic acid, methacrylic acid, maleic anhydride or their esters (impact modifiers (IM3)), especially functionalized ethylene/propylene/diene terpolymers (commonly known as EPDM rubbers). Diene monomers that can be used for synthesizing functionalized polyolefin impact modifiers of this class include notably conjugated dienes, such as isoprene and 1,3-butadiene, non conjugated dienes of 4 to 24 carbon atoms, such as 1,4-butadiene, 1,4-hexadiene, 1,5-hexadiene, 2,5-dimethyl-1,5-hexadiene and 1,4-octadiene, cyclic dienes, such as cyclopentadiene, cyclohexadiene, cyclooctadiene and dicyclopentadiene, alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo-[5.2.1.0.2.6]deca-3,8-diene. The content of recurring units derived from diene monomer in the functionalized polyolefin impact modifiers of this class is preferably from about 0.5% to about 10% by weight, and in particular from about 1% to about 5% by weight, based on the total weight of the functionalized polyolefin impact modifier. Mole fractions of ethylene units and higher alpha-olefin units in the ethylene-higher alpha-olefin copolymer rubbers generally range from about 40:60 to about 95:5.

Also suitable are functionalized block copolymers comprising at least two polymeric blocks, at least one block (B1) being a block of a polymer chosen from (IM1), (IM2) and (IM3) impact modifiers and at least one block (B2) being a block of an optionally substituted styrene, especially a block of a polystyrene homopolymer. Examples thereof are functionalized styrene—monoolefins block polymers functionalized SEBS, functionalized SEB, functionalized SEPS and functionalized SEP (where S is for styrene, E is for ethylene, P is for propylene and B is for butylene obtained by the hydrogenation of recurring units derived from butadiene).

Suitable functionalized polyolefin impact modifiers for use in certain embodiments of the present invention do not comprise recurring units derived from ethylene and/or propylene. Examples thereof are functionalized styrene—diolefins block polymers like functionalized Sβ, functionalized SβS, functionalized SIS and functionalized ABS (where S is for styrene, β is for butadiene, I is for isoprene and A is for acrylonitrile).

The functionalized polyolefin impact modifiers suitable for preparing the polymer compositions from which are made the safety equipments of the present invention are not limited the above described ones.

In certain embodiments of the present invention, the polymer composition can comprise additional components, notably mold release agents, plasticizers, lubricants, and thermal stabilizers, light stabilizers, antioxidants, opacifying agents like pigments, and fillers.

The levels of these optional additives will be determined for the particular use envisioned, with up to about 50 weight %, based on the total weight of the polymer composition, of such additional additives considered to be within the range of ordinary practice in the extrusion art.

A class of mold release agents of particular interest in certain embodiments of the present invention consists of aliphatic polyamides.

To the purpose of the present invention, “aliphatic polyamide” is intended to denote any polymer comprising more than 50 mole % of recurring units formed by the polycondensation reaction between at least one aliphatic diacid and at least one aliphatic diamine.

According to certain embodiments of the present invention, aliphatic polyamides comprising more than 75 mole % of recurring units formed by the polycondensation reaction between at least one aliphatic diacid having from 6 to 18 carbon atoms and at least one aliphatic diamine having from 4 to 12 carbon atoms, are preferred and aliphatic polyamides comprising more than 90 mole % of recurring units formed by the polycondensation reaction between at least one aliphatic diacid having from 8 to 16 carbon atoms and at least one aliphatic diamine having from 6 to 9 carbon atoms, are very preferred. Excellent results have been obtained with nylon 12. An exemplary nylon 12 is VESTAMID® L-1700, available from Degussa.

In certain embodiments of the present invention, the amount of the aliphatic polyamide in the polymer composition is up to about 10% by weight. In certain embodiments of the present invention, the aliphatic polyamide in the polymer composition is at least 2.5% by weight.

Suitable pigments for use in the present invention include carbon black. In certain embodiments, the pigment is present in the polymer composition in an amount of up to about 10% by weight.

Fillers can be reinforcing fillers, recurring fibers, or antistatic additives. Recurring fibers useful in forming filled articles and composite products may include glass fiber, carbon or graphite fibers and fibers formed of silicon carbide, alumina, boron and the like, as well as fibers formed from high temperature engineering resins such as, for example, poly(benzothiazole), poly(benzimidazole), polyarylates, poly(benzoxazole), polyarylethers and the like, and may include mixtures comprising two or more such fibers. Suitable fibers for certain embodiments of the present invention will be selected from glass fibers, carbon fibers and aromatic polyamide fibers such as the fibers sold by the DuPont Company under the trade name KEVLAR®. Other fillers which may also be used in the polymer composition include flake, spherical and fibrous particulate filler reinforcements and nucleating agents such as talc, mica, titanium dioxide, potassium titanate, silica, kaolin, chalk, alumina, mineral fillers, and the like. The fillers and recurring fiber may be used alone or in any combination.

It is another objective of the present invention to provide a polymer composition which is especially well suited for a making robust safety equipment that consistently meets or exceeds end use requirements and solves the problems associated with long flow lengths, inconsistent impact strength, and surface defects.

With this end in view, the present invention concerns a polymer composition comprising:
an aromatic polyamide, and
above 10 wt. %, based on the total weight of the polymer composition, of at least one functionalized polyolefin impact modifier having a glass transition temperature below −10° C.

The polymer composition according to the present invention has the same characteristics as the polymer composition comprised in the safety equipment according to the present invention as above detailed, in all its embodiments.

### EXAMPLES E1 to E9

### (Polymer Composition According to the Invention) and Comparative Example CE1 (Polymer Composition to the Contrary)

Three levels of functionalized polyolefin impact modifier and three types of flow modifier underwent testing. The various polymer compositions tested are listed in Table 1.

Polyphthalamide (PPA1) is a polyphthalamide consisting of about 55 wt. % of recurring units formed by the polycondensation reaction between phthalic diacid, essentially terephthalic diacid, and hexamethylene diamine, and about 45 wt. % of recurring units formed by the polycondensation reaction between adipic acid and hexamethylene diamine.

The various polymer compositions were evaluated for use in welding helmets/masks and the test data is given in Table 2. The flow modifiers evaluated included a linear low density polyethylene (LLDPE), an alkaline-earth salt of a long chain carboxylic acid, and nylon 12.

It was observed that an aliphatic polyamide, such as nylon 12, improved the surface appearance of the safety equipment molded from the aromatic polyamide composition. Safety equipment, according to certain embodiments of the present invention, such as welding helmets, formed from polymer compositions that contain nylon 12 as an additive, have more regular surface characteristics than welding helmets formed from polymer compositions without nylon 12.

TABLE 1

| | EXAMPLES | | | | | | | | | |
|---|---|---|---|---|---|---|---|---|---|---|
| Components | 1 | 2 | 3 | 4 | 5 | 6 | 7 | 8 | 9 | CE 1 |
| Polyphthalamide (PPA1) | 74.3 | 70.5 | 74.8 | 69.5 | 65.7 | 79.5 | 79.0 | 75.3 | 70.0 | 74.1 |
| (wt. %) | | | | | | | | | | |
| ROYALTUF ® 498 | 19 | 19 | 19 | 23.8 | 23.8 | 14.3 | 14.3 | 14.3 | 23.8 | 0 |
| 1% maleic anhydride | | | | | | | | | | |
| functionalized EPDM rubber | | | | | | | | | | |
| (wt. %) | | | | | | | | | | |
| EXXELOR ® PO 1015 | 0 | 0 | 0 | 0 | 0 | 0 | 0 | 0 | 0 | 9.7 |
| Maleic anhydride | | | | | | | | | | |
| functionalized polypropylene | | | | | | | | | | |
| (wt. %) | | | | | | | | | | |
| KRATON ® FG1901X | 0 | 0 | 0 | 0 | 0 | 0 | 0 | 0 | 0 | 9.7 |
| 1% maleic anhydride | | | | | | | | | | |
| functionalized SEBS block | | | | | | | | | | |
| copolymer (wt. %) | | | | | | | | | | |
| LLDPE (wt. %) | 1 | 0 | 0 | 1 | 0 | 0 | 1 | 0 | 0 | 0 |
| Nylon 12 (wt. %) | 0 | 4.8 | 0 | 0 | 4.8 | 0 | 0 | 4.8 | 0 | 4.8 |
| Alkaline-earth salt of a long | 0 | 0 | 0.5 | 0 | 0 | 0.5 | 0 | 0 | 0.5 | 0 |
| chain carboxylic acid | | | | | | | | | | |
| (wt. %) | | | | | | | | | | |
| Carbon black (wt. %) | 5 | 5 | 5 | 5 | 5 | 5 | 5 | 5 | 5 | 0 |
| Other conventional | 0.7 | 0.7 | 0.7 | 0.7 | 0.7 | 0.7 | 0.7 | 0.7 | 0.7 | 1.7 |
| ingredients of | | | | | | | | | | |
| polyphthalamide | | | | | | | | | | |
| compositions (antioxidant, | | | | | | | | | | |
| mold release, . . . ) | | | | | | | | | | |
| (wt. %) | | | | | | | | | | |
| Total (wt. %) | 100 | 100 | 100 | 100 | 100 | 100 | 100 | 100 | 100 | 100 |

TABLE 2

| | Izod | | Dynatup | Dynatup | Kayeness | |
|---|---|---|---|---|---|---|
| | Impact | Dynatup # | Energy | Total | viscosity | MFR |
| Exam- | (ft- | Ductile | Max Load | Energy | T5 | g/10 |
| ples | lbs/in) | Breaks | (ft-lbs) | (ft-lbs) | (poise) | min |
| 1 | 6.1 | 5 of 5 | 18.8 | 28.2 | 2880 | 9.9 |
| 2 | 4.0 | 5 of 5 | 19.8 | 31.8 | 2550 | 9.5 |
| 3 | 2.3 | 4 of 5 | 16.2 | 24.7 | 2180 | 29.9 |
| 4 | 18.4 | 5 of 5 | 20.4 | 32.5 | 3880 | 1.5 |
| 5 | 11.2 | 5 of 5 | 18.3 | 30.7 | 3230 | 4.4 |
| 6 | 2.9 | 5 of 5 | 13.2 | 13.5 | 1810 | 51 |
| 7 | 2.8 | 5 of 5 | 23.4 | 35.9 | 2670 | 19.9 |
| 8 | 3.3 | 5 of 5 | 20.9 | 30.3 | 2550 | 19.9 |
| 9 | 4.2 | 0 of 5 | 4.5 | 4.5 | 2850 | 5.4 |
| CE1 | 0.77 | 4 of 5 | 24.0 | 37.0 | 2570 | 5.1 |

The Izod impact test was run at standard ASTM conditions. The Dynatup impact test was run according to ASTM D3763 on ⅛ inch plaques. The BB test comprises shooting a s at various velocities and then inspecting the test sample for damage from the he polymer compositions were evaluated for use in protective face and head three criteria:
1. Impact data based on Izod, Dynatup impact maximum energy and the number of ductile breaks,
2. flow properties measured by melt flow rate (MFR), and viscosity as measured with a Kayeness capillary viscosimeter, in which the viscosity was measured at 394 sect⁻¹ after 5 minutes (referred to as T5) according to ASTM D3835, and
3. internal injection molding evaluations.

All 12 formulations were molded in an insert plaque mold where processing, surface appearance and weld line aesthetics were evaluated and compared.

The following observations were made based on the molding trials.

### EXAMPLE E10

### (Safety Equipment According to the Invention) and Comparative Example CE2 (Safety Equipment to the Contrary)

Welding helmets were made from the polymer composition according to example E5 (welding helmets E10) on one hand, and from the polymer composition according to comparative example E1 (welding helmets CE2) on the other hand.

Example E10 was processed initially exactly according to the same conditions as Comparative Example CE2. The melt temperature was 618° F. In these conditions, the surfaces of the welding helmets E10 were similar in appearance to the surfaces of the control welding helmets CE2 except the flow lines were more pronounced. However, reducing the injection speed improved the flow lines, so that after optimizing the process conditions, the surface appearance of the welding helmets E10, according to the invention, was similar to the surface appearance of the control welding helmets CE2. In the case of example E10, no part sticking was detected.

A welding helmet E10 was tested and passed successfully the 300 ft/sec BB impact test.

### EXAMPLE E11

### Safety Equipment According to the Invention

Welding helmets were also made from the polymer composition according to example E2 (welding helmets E11).

Example E11 was processed initially exactly under the same conditions as comparative example CE2. In these conditions, the surface appearance of the welding helmets E11 was cleaner and clearer than the surface appearance of the welding helmets E10, and the flow lines were less apparent. As for example E10, the injection speed was reduced to minimize flow lines. After optimizing the process conditions, the surface appearance of the welding helmets E11, according to the invention, was similar to the surface appearance of the control welding helmets CE2. In the case of example E11, no part sticking was detected.

A welding helmet E11 was tested and passed successfully the 300 ft/sec BB impact test.

Welding helmets (in particular protective faces and head gears) E10 and E11, according to the invention, dramatically demonstrated improved impact strength relative to control welding helmets CE2.

1-18. (canceled)

19. A safety equipment comprising a polymer composition comprising:
an aromatic polyamide, and
above 10 wt. %, based on the total weight of the polymer composition, of at least one functionalized polyolefin impact modifier having a glass transition temperature below −10° C.

20. The safety equipment according to claim 19, which is a protective face or head gear.

21. The safety equipment according to claim 19, which is a welding helmet or mask.

22. The safety equipment according to claim 19, wherein the safety equipment is a safety equipment to protect a wearer.

23. The safety equipment according to claim 22, wherein the aromatic polyamide is a polyphthalamide having a melting point greater than 280° C.

24. The safety equipment according to claim 22, wherein the aromatic polyamide has a melting point greater than 280° C.

25. The safety equipment according to claim 24, wherein the functionalized polyolefin impact modifier has a glass transition temperature of less than −30° C.

26. The safety equipment according to claim 24, wherein the functionalized polyolefin impact modifier is a functionalized ethylene/propylene/diene terpolymer.

27. The safety equipment according to claim 24, wherein the polymer composition comprises at least about 15% by weight of the functionalized polyolefin impact modifier.

28. The safety equipment according to claim 24, wherein the polymer composition comprises up to about 35 weight % of the functionalized polyolefin impact modifier.

29. The safety equipment according to claim 24, wherein the polymer composition further comprises an aliphatic polyamide.

30. The safety equipment according to claim 24, wherein the polymer composition further comprises nylon 12.

31. A safety equipment to protect a wearer comprising a polymer composition comprising:
an aromatic polyamide having a melting point greater than 280° C., and
above 10 wt. %, based on the total weight of the polymer composition, of at least one functionalized polyolefin impact modifier having a glass transition temperature below −10° C., wherein said safety equipment is a protective face or head gear.

32. The safety equipment according to claim 31, wherein the aromatic polyamide is a polyphthalamide.

33. The safety equipment according to claim 31, wherein the functionalized polyolefin impact modifier is a functionalized ethylene/propylene/diene terpolymer.

34. The safety equipment according to claim 31, wherein the polymer composition further comprises an aliphatic polyamide.

35. The safety equipment according to claim 31, wherein the polymer composition further comprises nylon 12.

36. A polymer composition comprising:
an aromatic polyamide, and
above 10 wt. %, based on the total weight of the polymer composition, of at least one functionalized polyolefin impact modifier having a glass transition temperature below −10° C.

37. The polymer composition according to claim 36, which further comprises an aliphatic polyamide.

38. The e polymer composition according to claim 36, wherein the aromatic polyamide is a polyphthalamide having a melting point greater than 280° C.

39. The polymer composition according to claim 37, wherein the functionalized polyolefin impact modifier is a functionalized ethylene/propylene/diene terpolymer.

40. The polymer composition according to claim 36, which further comprises an nylon 12.

41. The polymer composition according to claim 40, wherein the aromatic polyamide is a polyphthalamide having a melting point greater than 280° C.

42. The polymer composition according to claim 40, wherein the functionalized polyolefin impact modifier is a functionalized ethylene/propylene/diene terpolymer.
